(19) United States
(12) Patent Application Publication
(10) Pub. No.: US 2012/0086526 A1
(43) Pub. Date: Apr. 12, 2012

(54) WIRELESS IC DEVICE AND COUPLING METHOD FOR POWER FEEDING CIRCUIT AND RADIATION PLATE

(75) Inventor: Noboru KATO, Nagaokakyo-shi (JP)

(73) Assignee: MURATA MANUFACTURING CO., LTD., Nagaokakyo-shi (JP)

(21) Appl. No.: 13/325,273

(22) Filed: Dec. 14, 2011

Related U.S. Application Data
(63) Continuation of application No. PCT/JP2010/057668, filed on Apr. 30, 2010.

(30) Foreign Application Priority Data
Jun. 19, 2009 (JP) 2009-147060
Oct. 7, 2009 (JP) 2009-233195

(51) Int. Cl. H01P 5/00

(52) U.S. Cl. 333/24 R

(57) ABSTRACT

A wireless IC device includes a wireless IC chip, a power feeding circuit substrate including a power feeding circuit including inductance elements, and radiation plates including plate-shaped coupling units. The inductance elements have spiral shapes and are wound in directions opposite to each other. The plate-shaped coupling units in the radiation plates are disposed in a vicinity of the inductance elements so as to be perpendicular or substantially perpendicular to the winding axes of the inductance elements, and eddy currents occur in the plate-shaped coupling units so as to couple the power feeding circuit and the radiation plates with each other. The plate-shaped coupling units may also have spiral shapes.

### BACKGROUND OF THE INVENTION

1. Field of the Invention

The present invention relates to a wireless IC device, and in particular, relates to a wireless IC device used for an RFID (Radio Frequency Identification) system and a coupling method for a power feeding circuit and a radiation plate included in the wireless IC device.

2. Description of the Related Art

In the past, as a management system for goods, there has been developed an RFID system in which communication between a reader/writer generating an induction electromagnetic field and a wireless tag (also referred to as a wireless IC device) storing therein predetermined information assigned to goods is established on the basis of a non-contact method and information is transmitted. As a wireless tag used for this type of RFID system, in Japanese Unexamined Patent Application Publication No. 10-293828, a data carrier is described that includes an IC circuit, a primary coil antenna, and a secondary coil antenna and causes the primary coil antenna and the secondary coil antenna to be electromagnetically coupled to each other.

However, in the above-mentioned data carrier, the degree of coupling between the primary coil antenna and the secondary coil antenna is small, and a coupling loss occurs. While it is possible to improve the degree of coupling of a magnetic field by increasing the inductance value of the secondary coil antenna, this results in the secondary coil antenna being large in size. In addition, since the coupling depends on a communication frequency, it is difficult to decrease the size of the secondary coil antenna. Furthermore, when both the antennas are also electric-field-coupled to each other, there occurs a problem that the degree of coupling is small, in the same way as described above.

### SUMMARY OF THE INVENTION

Therefore, preferred embodiments of the present invention provide a wireless IC device capable of coupling a power feeding circuit including a wireless IC and a radiation plate with each other with a high degree of coupling and significantly decreasing the size of the radiation plate, and a coupling method for the power feeding circuit and the radiation plate.

A wireless IC device according to a preferred embodiment of the present invention includes a wireless IC, a power feeding circuit coupled with the wireless IC and including a resonant circuit and/or matching circuit including at least two inductance elements, and a radiation plate radiating a transmission signal supplied from the power feeding circuit and/or supplying a received signal to the power feeding circuit, wherein the at least two inductance elements have spiral shapes wound in directions opposite to each other and winding axes of the individual inductance elements are disposed at different positions, and the radiation plate includes two plate-shaped coupling units, and the plate-shaped coupling units are disposed in a vicinity of the at least two inductance elements so as to be nearly perpendicular to the winding axes of the inductance elements, respectively.

A wireless IC device according to another preferred embodiment of the present invention includes a wireless IC, a power feeding circuit coupled with the wireless IC and including a resonant circuit and/or matching circuit including at least two inductance elements, and a radiation plate radiating a transmission signal supplied from the power feeding circuit and/or supplying a received signal to the power feeding circuit, wherein the at least two inductance elements have spiral shapes wound in directions opposite to each other and the winding axes of the individual inductance elements are disposed at different positions, and the radiation plate includes two spiral-shaped coupling units, the spiral-shaped coupling units are disposed in a vicinity of the at least two inductance elements so that the spiral surfaces thereof are nearly perpendicular to the winding axes of the inductance elements, respectively, and the spiral-shaped coupling units are wound in directions opposite to the winding directions of the inductance elements adjacent to the spiral-shaped coupling units, respectively.

A coupling method for a power feeding circuit and a radiation plate according to another preferred embodiment of the present invention, is a coupling method for a power feeding circuit including a resonant circuit and/or matching circuit including at least two inductance elements and a radiation plate radiating a transmission signal supplied from the power feeding circuit and/or supplying a received signal to the power feeding circuit, wherein the at least two inductance elements have spiral shapes wound in directions opposite to each other and the winding axes of the individual inductance elements are disposed at different positions, the radiation plate includes two plate-shaped coupling units, and the two plate-shaped coupling units are disposed in a vicinity of the at least two inductance elements so as to be nearly perpendicular to the winding axes of the inductance elements, respectively, and eddy currents occur in the two plate-shaped coupling units so as to couple the power feeding circuit and the radiation plate with each other.

A coupling method for a power feeding circuit and a radiation plate according to yet another preferred embodiment of the present invention, is a coupling method for a power feeding circuit including a resonant circuit and/or matching circuit including at least two inductance elements and a radiation plate radiating a transmission signal supplied from the power feeding circuit and/or supplying a received signal to the power feeding circuit, wherein the at least two inductance elements have spiral shapes wound in directions opposite to each other and the winding axes of the individual inductance elements are disposed at different positions, the radiation plate includes two spiral-shaped coupling units, and the two spiral-shaped coupling units are disposed in a vicinity of the at least two inductance elements so that the spiral surfaces thereof are nearly perpendicular to the winding axes of the inductance elements, respectively, the spiral-shaped coupling units are wound in directions opposite to the winding directions of the inductance elements adjacent to the spiral-shaped coupling units, respectively, and eddy currents occur in the two spiral-shaped coupling units, thereby coupling the power feeding circuit and the radiation plate with each other.

In the wireless IC device and the coupling method according to first and third preferred embodiments of the present invention, since the plate-shaped coupling units in the radiation plate are disposed in a vicinity of the inductance elements so as to be nearly perpendicular to the winding axes of the inductance elements wound in directions opposite to each other, eddy currents occur in the two plate-shaped coupling units. The directions of the eddy currents are opposite to each other in the two plate-shaped coupling units, and a current flows through the radiation plate. More specifically, the power feeding circuit and the radiation plate are coupled with each other owing to the eddy currents. Since, in such coupling due to the eddy currents, the degree of coupling is high and the coupling does not depend on a communication frequency, the size of the radiation plate may be small.

In the wireless IC device and the coupling method according to the second and fourth preferred embodiments of the present invention, the spiral-shaped coupling units in the radiation plate are disposed in a vicinity of the inductance elements so that the spiral surfaces thereof are nearly perpendicular to the winding axes of the inductance elements wound in directions opposite to each other, and the spiral-shaped coupling units are wound in directions opposite to the winding directions of the inductance elements adjacent to the spiral-shaped coupling units, respectively. Therefore, eddy currents occur in the two spiral-shaped coupling units. The directions of the eddy currents are opposite to each other in the two spiral-shaped coupling units, and a current flows through the radiation plate. More specifically, the power feeding circuit and the radiation plate are coupled with each other owing to the eddy currents. Since, in such coupling due to the eddy currents, the degree of coupling is high and the coupling does not depend on a communication frequency, the size of the radiation plate may be small.

According to various preferred embodiments of the present invention, it is possible to couple the power feeding circuit including the wireless IC and the radiation plate with each other with the high degree of coupling due to eddy currents, and since the coupling does not depend on a frequency, it is possible to significantly decrease the size the radiation plate.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a wireless IC device according to a first preferred embodiment of the present invention.

FIG. 2 is a perspective view illustrating a power feeding circuit substrate configuring the wireless IC device according to the first preferred embodiment of the present invention.

FIG. 3 is a perspective view illustrating a laminated structure of the power feeding circuit substrate illustrated in FIG. 2.

FIG. 4 is an equivalent circuit diagram including a power feeding circuit and a radiation plate according to the first preferred embodiment of the present invention.

FIGS. 5A-5F are explanatory diagrams illustrating a coupling method for the power feeding circuit and the radiation plate according to the first preferred embodiment of the present invention.

FIG. 6 is a perspective view illustrating a laminated structure of an example of a modification to the power feeding circuit substrate.

FIG. 7 is an equivalent circuit diagram including an example of a modification to the power feeding circuit substrate, illustrated in FIG. 6, and the radiation plate.

FIG. 8 is a perspective view illustrating a wireless IC device according to a second preferred embodiment of the present invention.

FIG. 9 is a perspective view illustrating a power feeding circuit substrate and a wireless IC chip, which configure the wireless IC device according to the second preferred embodiment of the present invention.

FIG. 10 is a plan view illustrating a laminated structure of the power feeding circuit substrate according to the second preferred embodiment of the present invention.

FIG. 11 is an equivalent circuit diagram including a power feeding circuit and a radiation plate according to the second preferred embodiment of the present invention.

FIG. 12 is a plan view illustrating a laminated structure of an example of a modification to the power feeding circuit substrate.

FIG. 13 is an equivalent circuit diagram including an example of a modification to the power feeding circuit substrate, illustrated in FIG. 12, and the radiation plate.

FIG. 14 is a pattern diagram for explaining the change of impedance of the radiation plate.

FIG. 15 is a perspective view illustrating a wireless IC device according to a third preferred embodiment of the present invention.

FIG. 16 is an exploded plan view illustrating a structure of a radiation plate according to the third preferred embodiment of the present invention.

FIGS. 17A-17E are explanatory diagrams illustrating a coupling method for the power feeding circuit and the radiation plate according to the third preferred embodiment of the present invention.

FIGS. 18A-18C are explanatory diagrams illustrating a coupling method for the power feeding circuit and the radiation plate according to the third preferred embodiment of the present invention and the continuation of FIGS. 17A-17E.

### DETAILED DESCRIPTION OF THE PREFERRED EMBODIMENTS

Hereinafter, preferred embodiments of a wireless IC device and a coupling method according to the present invention will be described with reference to accompanying drawings.

### First Preferred Embodiment

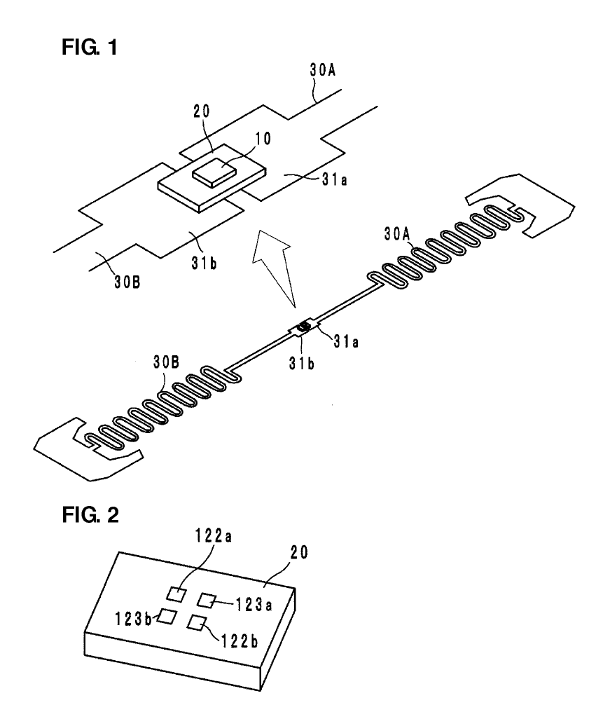

A wireless IC device that is a first preferred embodiment is a device used in a UHF band, and, as illustrated in FIG. 1, includes a wireless IC chip 10 processing a transmission/reception signal of a predetermined frequency, a power feeding circuit substrate 20 mounted with the wireless IC chip 10, and two radiation plates 30A and 30B.

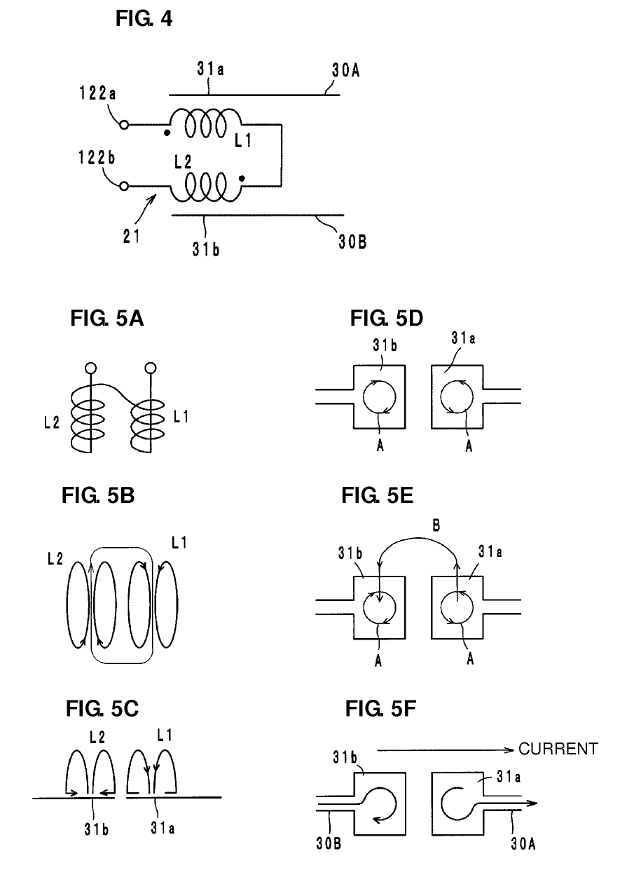

As illustrated as an equivalent circuit in FIG. 4, the power feeding circuit substrate 20 includes a power feeding circuit 21 including a resonant circuit/matching circuit in which inductance elements L1 and L2 are included that have substantially the same inductance values and preferably have spiral shapes wound in directions opposite to each other. The winding axes of the inductance elements L1 and L2 are disposed at different positions and parallel or substantially parallel to each other, in plan view.

The wireless IC chip 10 includes a clock circuit, a logic circuit, a memory circuit, and the like, necessary information is stored therein, and a pair of input-output terminal electrodes and a pair of mounting terminal electrodes, not illustrated, are provided on the rear surface thereof. The input-output terminal electrodes are electrically connected to power feeding terminal electrodes 122a and 122b located on the power feeding circuit substrate 20 through metal bumps or the like, and the mounting terminal electrodes are electrically connected to mounting electrodes 123a and 123b through metal bumps or the like, for example. In addition, it may be that the wireless IC chip 10 and the power feeding circuit 21 are not electrically connected to each other, and are coupled (electromagnetically coupled) with each other.

The radiation plates 30A and 30B preferably are individually arranged to have meander shapes on a flexible resin film (not illustrated), and include non-magnetic metal material. End portions of the radiation plates 30A and 30B are regarded as plate-shaped coupling units 31a and 31b, and the power feeding circuit substrate 20 is stuck onto the coupling units 31a and 31b. More specifically, the plate-shaped coupling unit 31a is disposed in a vicinity of the inductance element L1 so as to be perpendicular or substantially perpendicular to the winding axis of the inductance element L1, and the plate-shaped coupling unit 31b is disposed in a vicinity of the inductance element L2 so as to be perpendicular to the winding axis of the inductance element L2. In addition, it is desirable that the sizes of the plate-shaped coupling units 31a and 31b are large enough to cover the aperture planes of coil patterns configuring the inductance elements L1 and L2.

The inductance elements L1 and L2 included in the power feeding circuit 21 are magnetically coupled with each other in a reverse phase to resonate with a frequency processed by the wireless IC chip 10, and coupled with the coupling units 31a and 31b in the radiation plates 30A and 30B owing to eddy currents, in such a way as described later. In addition, the power feeding circuit 21 establishes matching between the impedance of the wireless IC chip 10 and the impedances of the radiation plates 30A and 30B. The inductance values of the inductance elements L1 and L2 may be different from each other, or may be substantially equal to each other. When the inductance value of the inductance elements L1 and L2 are caused to be substantially equal to each other, the leakage magnetic field of a closed loop is reduced, and it is possible to reduce a coupling loss.

Here, the coupling between the power feeding circuit 21 and the radiation plates 30A and 30B will be described with reference to FIGS. 5A-5F. First, since the inductance elements L1 and L2 are wound in directions opposite to each other (refer to FIG. 5A) and the current paths thereof are mirror-reversed, magnetic fields are also reversed, and a far magnetic field becomes zero. Therefore, the power feeding circuit substrate 20 does not function as an antenna. In addition, since the elements L1 and L2 are wound in directions opposite to each other, a magnetic field flows as one closed loop, and does not leak to the outside (refer to FIG. 5B). Accordingly, a portion of energy is not radiated further other than coupling as in normal magnetic field coupling.

When focusing attention on the plate-shaped coupling units 31a and 31b facing the inductance elements L1 and L2, since magnetic fields occurring from the elements L1 and L2 perpendicularly affect the coupling units 31a and 31b (refer to FIG. 5C), eddy currents A occur in the coupling units 31a and 31b (refer to FIG. 5D). Directions in which the eddy currents A flow are opposite to each other in the adjacent plate-shaped coupling units 31a and 31b, magnetic fields occurring from the eddy currents A define one closed loop, and a secondary magnetic field B causing the magnetic fields to draw close to each other occurs (refer to FIG. 5E). Electrons for the neutralization of a magnetic field attempt to flow from one end portion to the other end portion with originating from the secondary magnetic field B. In addition, even if the radiation plates 30A and 30B are separated into two portions, currents flow into and from the adjacent coupling units 31a and 31b from and to the outside, and currents flow through the radiation plates 30A and 30B (refer to FIG. 5F).

In addition, as in a second preferred embodiment illustrated below (refer to FIG. 8), a current also flows through a loop-shaped radiation plate 30. In this way, in a coupling method utilizing eddy currents, the path length of a radiation plate is not influenced. In addition, that a radiation plate is divided into two plates or is one loop-shaped plate does not influence a coupling efficiency. In this regard, however, when the path lengths of the radiation plates 30A and 30B area about λ/4 (a total path length is about λ/2), a voltage becomes a maximum and a current becomes a minimum at an end portion, and a resonance condition is satisfied. Therefore, it is easier for a current to flow.

More specifically, owing to a magnetic field generated by adjacent eddy currents, eddy currents flow through the radiation plates 30A and 30B with originating from the facing plate-shaped coupling units 31a and 31b. In this way, unlike magnetic field coupling or electric field coupling of the related art, a magnetic field perpendicularly runs into the plate-shaped coupling units 31a and 31b, thereby actively generating eddy currents, and hence energy causing a current to flow through the radiation plates 30A and 30B occurs with originating from adjacent eddy currents. Such transmission (coupling) of energy is realized when a plate perpendicularly or substantially perpendicularly facing a pair of coils whose directions are opposite to each other is disposed and eddy currents flows through the plate. Accordingly, even if a plate-shaped coupling unit is only disposed for one of the inductance elements L1 and L2, it is difficult to transmit energy to the radiation plate.

The above-mentioned new coupling method based on the eddy currents does not depend on a frequency if a magnetic field is strong, and in an HF band such as 13.56 MHz or the like which is a low frequency, it is also possible to couple the power feeding circuit 21 with the radiation plates 30A and 30B. Also in a high-frequency wave, an efficiency of transmitting energy to the radiation plates 30A and 30B is high, and even the small power feeding circuit substrate 20 can realize a degree of coupling ranging from about 0.8 to about 1.0 (specifically, greater than or equal to about 0.96) with respect to the plate-shaped coupling units 31a and 31b, for example. The degree of coupling is a value converted on the basis of a minimum driving power that is about −14.7 dBm at the time of direct coupling in which the power feeding circuit 21 is DC-connected to the radiation plates 30A and 30B and about −11.5 dBm at the time of the present coupling due to the eddy currents. As a reason that a slight coupling loss occurs in this experiment, the resistance component and the dielectric loss (tans) of the coil-shaped electrode pattern may be considered. In addition, the deviations of the inductance values of the inductance elements L1 and L2 also causes the occurrence of the leakage magnetic field of the closed loop, and causes a coupling loss.

Accordingly, the power feeding circuit 21 transmits, to the radiation plates 30A and 30B, a transmission signal having a predetermined frequency, transmitted from the wireless IC chip 10, and selects a reception signal having a predetermined frequency from a signal received by the radiation plates 30A and 30B to supply the selected signal to the wireless IC chip 10. Therefore, in the wireless IC device, the wireless IC chip 10 is caused to operate by the signal received by the radiation plates 30A and 30B, and a response signal from the wireless IC chip 10 is radiated from the radiation plates 30A and 30B to the outside.

As described above, in the present wireless IC device, the frequency of the signal is set by the power feeding circuit 21 provided in the power feeding circuit substrate 20. Therefore, even if the present wireless IC device is attached to various kinds of goods, the present wireless IC device operates without change, the fluctuation of a radiation characteristic is suppressed, and it is not necessary to perform the design change of the radiation plates 30A and 30B or the like, with respect to individual goods. In addition, the frequency of the transmission signal radiated from the radiation plates 30A and 30B and the frequency of the reception signal supplied to the wireless IC chip 10 substantially correspond to the resonance frequency of the power feeding circuit 21 in the power feeding circuit substrate 20, and the maximum gain of a signal is substantially determined by at least one of the size and the shape of the power feeding circuit 21, a distance between the power feeding circuit and the radiation plates 30A and 30B, and a medium. Since the frequency of the transmission/reception signal is determined in the power feeding circuit substrate 20, without depending on the shapes and the sizes of the radiation plates 30A and 30B, a disposition relationship therebetween, or the like, it is possible to obtain a stable frequency characteristic without the frequency characteristic being changed, even if the wireless IC device is rolled or sandwiched between dielectric materials, for example.

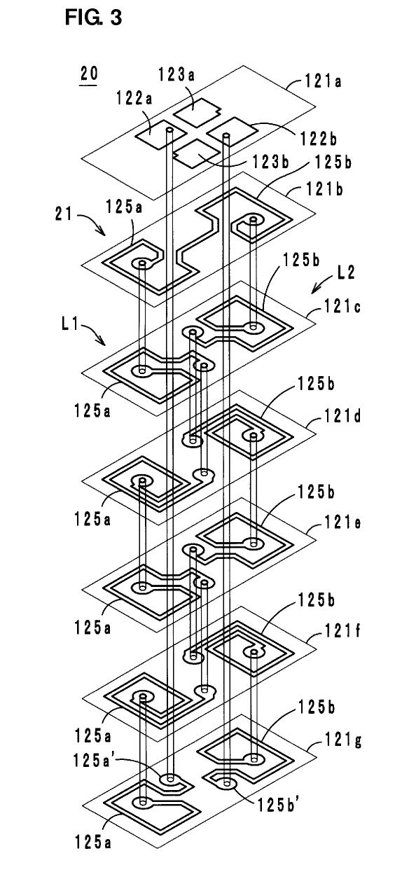

Here, the configuration of the power feeding circuit substrate 20 will be described with reference to FIG. 3. The power feeding circuit substrate 20 is preferably obtained by laminating, crimping, and firing ceramic sheets 121a to 121g including dielectric material or magnetic material, for example. The power feeding terminal electrodes 122a and 122b and the mounting electrodes 123a and 123b are located on the sheet 121a in an uppermost layer, and wiring electrodes 125a and 125b are located on the sheet 121b to 121g.

The inductance elements L1 and L2 are formed preferably by individually connecting the wiring electrodes 125a and 125b having spiral shapes through via hole conductors, and integrated using the wiring electrodes 125a and 125b on the sheet 121b. An end portion 125a′ of the wiring electrode 125a on the sheet 121g is connected to the power feeding terminal electrode 122a through a via hole conductor, and an end portion 125b′ of the wiring electrode 125b on the sheet 121g is connected to the power feeding terminal electrode 122b through a via hole conductor.

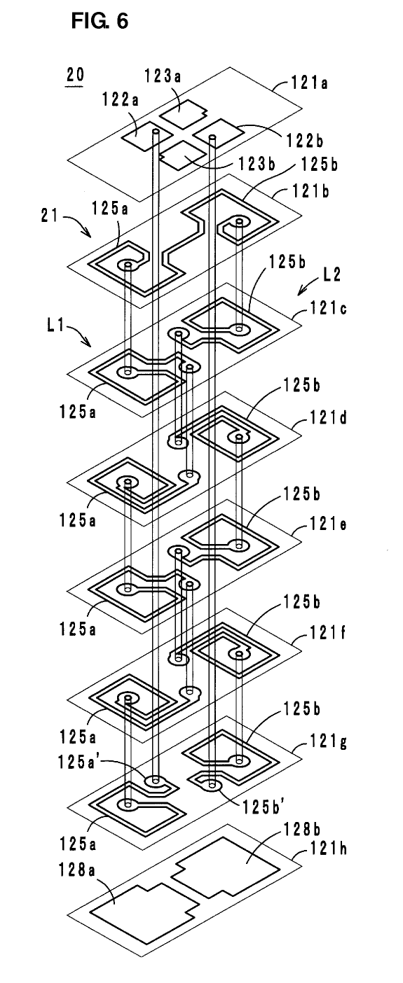

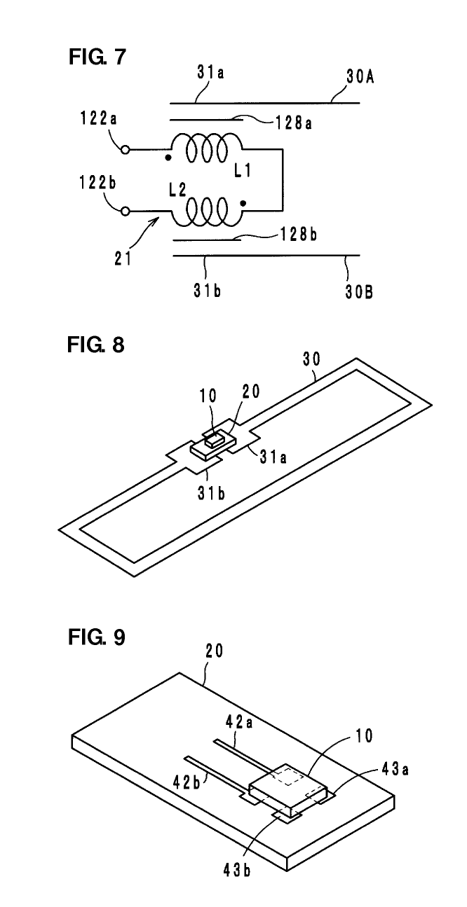

FIG. 6 illustrates an example of a modification to the power feeding circuit substrate 20. The power feeding circuit substrate 20 is obtained preferably by providing the sheet 121h in the lowermost layer of the laminated structure illustrated in FIG. 3 and forming flat electrodes 128a and 128b on the sheet 121h. FIG. 7 illustrates the equivalent circuit thereof.

Even if the flat electrodes 128a and 128b are caused to lie between the inductance elements L1 and L2 and the plate-shaped coupling units 31a and 31b, the coupling between the inductance elements L1 and L2 and the radiation plates 30A and 30B is the same as described above. While eddy currents are generated in the flat electrodes 128a and 128b, magnetic fields from the inductance elements L1 and L2 are also transmitted to the plate-shaped coupling units 31a and 31b adjacent to the flat electrodes 128a and 128b. More specifically, each of a pair of the flat electrode 128a and the plate-shaped coupling unit 31a and a pair of the flat electrode 128b and the plate-shaped coupling unit 31b functions as a plate blocking a magnetic field. Accordingly, currents flow through the radiation plates 30A and 30B. In addition, the flat electrodes 128a and 128b may be formed on the outer surface (the rear surface of the sheet 121h) of the power feeding circuit substrate 20. By forming the flat electrodes 128a and 128b on the outer surface, it is possible to use the flat electrodes 128a and 128b as mounting electrodes.

### Second Preferred Embodiment

As illustrated in FIG. 8, in a wireless IC device according to a second preferred embodiment of the present invention, a radiation plate 30 including the plate-shaped coupling units 31a and 31b is loop-shaped, and the other components are preferably the same as those of the first preferred embodiment. The plate-shaped coupling units 31a and 31b are perpendicularly or substantially perpendicularly disposed in a vicinity of the inductance elements L1 and L2 wound in directions opposite to each other, and hence the power feeding circuit 21 is coupled with the plate-shaped coupling units 31a and 31b owing to eddy currents, and a current flows through the loop-shaped radiation plate 30. This is the same as described in the first preferred embodiment.

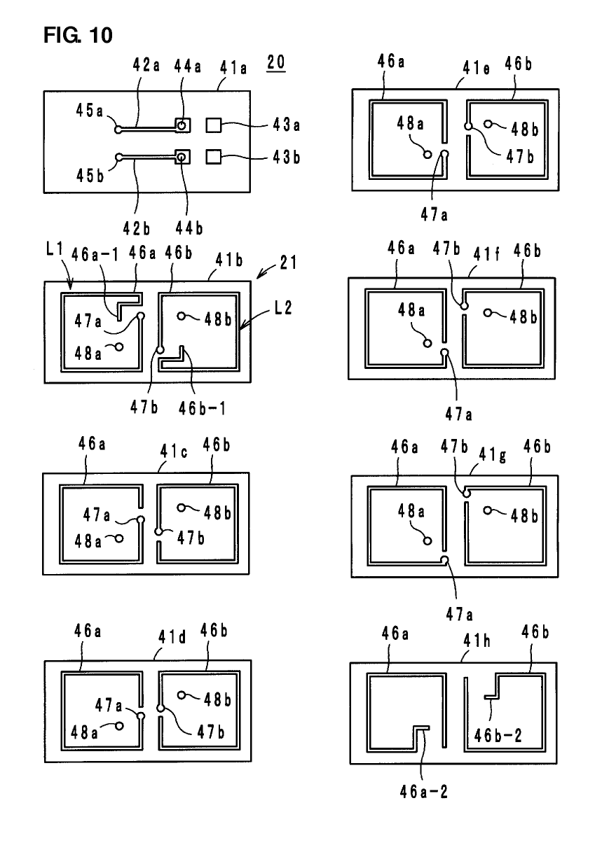

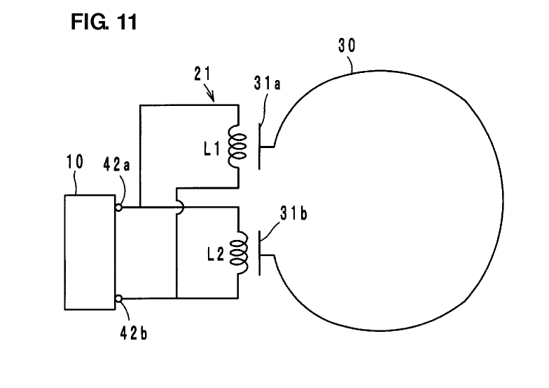

FIG. 11 illustrates an equivalent circuit in the present second preferred embodiment. In addition, as the power feeding circuit substrate 20, a power feeding circuit substrate having a laminated structure illustrated in FIG. 10 is preferably used. More specifically, the power feeding circuit substrate 20 is obtained preferably by laminating, crimping, and firing ceramic sheets 41a to 41h including dielectric material or magnetic material. Power feeding terminal electrodes 42a and 42b, mounting electrodes 43a and 43b, and via hole conductors 44a, 44b, 45a, and 45b are formed on the sheet 41a in an uppermost layer. Wiring electrodes 46a and 46b configuring the inductance elements L1 and L2 are formed on each of the sheet 41b in a second layer to the sheet 41h in an eighth layer, and via hole conductors 47a, 47b, 48a, and 48b are formed when necessary.

By laminating the above-mentioned sheets 41a to 41h, the inductance element L1 is located where the wiring electrodes 46a are connected in a spiral shape through the via hole conductor 47a, and the inductance element L2 is located where the wiring electrodes 46b are connected in a spiral shape through the via hole conductor 47b. In addition, capacitance is generated between the lines of the wiring electrodes 46a and 46b.

An end portion 46a-1 of the wiring electrode 46a on the sheet 41b is connected to the power feeding terminal electrode 42a through the via hole conductor 45a, and an end portion 46a-2 of the wiring electrode 46a on the sheet 41h is connected to the power feeding terminal electrode 42b through the via hole conductors 48a and 45b. An end portion 46b-1 of the wiring electrode 46b on the sheet 41b is connected to the power feeding terminal electrode 42b through the via hole conductor 44b, and an end portion 46b-2 of the wiring electrode 46b on the sheet 41h is connected to the power feeding terminal electrode 42a through the via hole conductors 48b and 44a.

As illustrated in FIG. 9, the power feeding terminal electrodes 42a and 42b are electrically connected to the input-output terminal electrodes in the wireless IC chip 10, and the mounting electrodes 43a and 43b are electrically connected to mounting terminal electrode in the wireless IC chip 10.

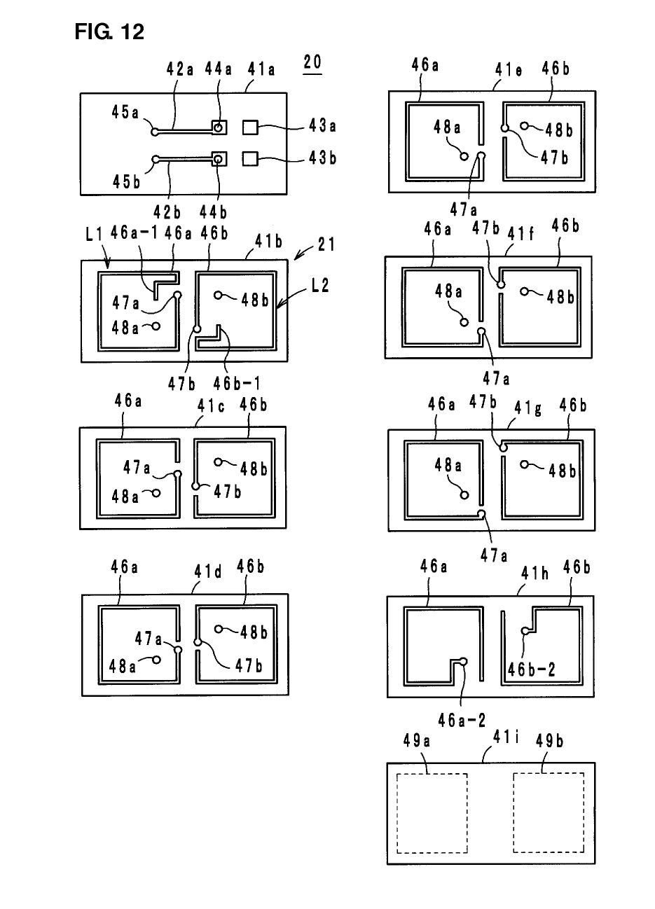

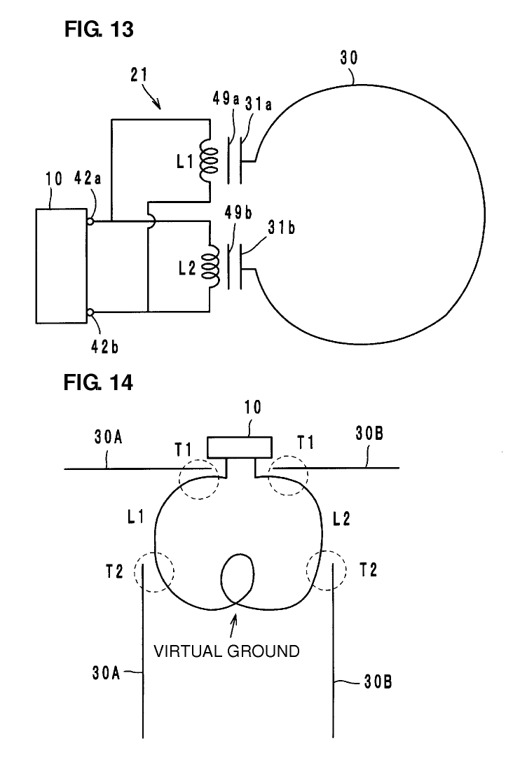

FIG. 12 illustrates an example of a modification to the power feeding circuit substrate 20, and FIG. 13 illustrates the equivalent circuit thereof. The power feeding circuit substrate 20 is obtained preferably by providing flat electrodes 49a and 49b on the rear surface of the sheet 41i provided in the lowermost layer of the power feeding circuit substrate 20 illustrated in FIG. 10, the outer shapes of the flat electrodes 49a and 49b being equal to or smaller than those of the inductance elements L1 and L2 when the perspective plane of the power feeding circuit substrate 20 is viewed.

Even if the flat electrodes 49a and 49b are caused to lie between the inductance elements L1 and L2 and the plate-shaped coupling units 31a and 31b, the coupling between the inductance elements L1 and L2 and the radiation plate 30 is the same as described above. While eddy currents are generated in the flat electrodes 49a and 49b, magnetic fields from the inductance elements L1 and L2 are also transmitted to the plate-shaped coupling units 31a and 31b adjacent to the flat electrodes 49a and 49b. More specifically, each of a pair of the flat electrode 49a and the plate-shaped coupling unit 31a and a pair of the flat electrode 49b and the plate-shaped coupling unit 31b functions as a plate blocking a magnetic field. Accordingly, a current flows through the radiation plate 30.

In the above-mentioned individual preferred embodiments, a case in which the end portions of the inductance elements L1 and L2 are connected to each other (refer to FIG. 3 and FIG. 4), and a case in which the inductance elements L1 and L2 are connected in parallel to the wireless IC chip 10 using the power feeding terminal electrodes 42a and 42b (refer to FIG. 10 and FIG. 11) have been illustrated. When the end portions of the inductance elements L1 and L2 are connected in series to each other, the amount of a flowing current becomes larger, and the amount of a magnetic field also becomes larger. Therefore, it is possible to further enhance the degree of coupling.

Incidentally, by changing distances of coupling portions from virtual ground with respect to the inductance elements L1 and L2 as illustrated in FIG. 14, it is possible to change the impedances of the radiation plates 30A and 30B. When coupling portions are far from the virtual ground as coupling portions T1, the impedances of the radiation plates 30A and 30B become large. When coupling portions get near to the virtual ground as coupling portions T2, the impedances of the radiation plates 30A and 30B become small. Such changes of the coupling portions can be performed by changing an interlayer connection relationship between coil-shaped wiring electrodes configuring the inductance elements L1 and L2.

### Third Preferred Embodiment

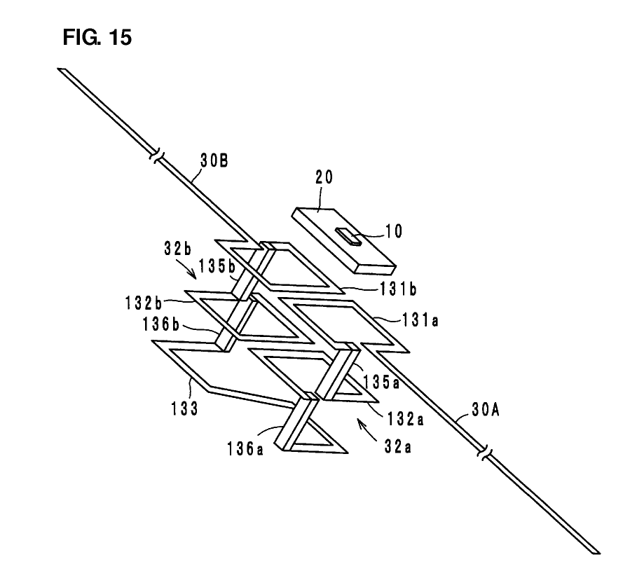

As illustrated in FIG. 15, a wireless IC device according to a third preferred embodiment includes a wireless IC chip 10, a power feeding circuit substrate 20 mounted with the wireless IC chip 10, and two linear radiation plates 30A and 30B. The power feeding circuit substrate 20 is preferably the same as that illustrated in the first preferred embodiment (with respect to the inner structure, refer to FIG. 3, for example).

End portions of the radiation plates 30A and 30B are preferably spiral-shaped coupling units 32a and 32b, respectively. The spiral-shaped coupling units 32a and 32b are disposed in a vicinity of the two inductance elements L1 and L2 (refer to the first preferred embodiment) so that the spiral surfaces thereof are perpendicular or substantially perpendicular to the winding axes of the inductance elements L1 and L2, respectively, and the spiral-shaped coupling units 32a and 32b are wound in directions opposite to the winding directions of the adjacent inductance elements L1 and L2, respectively. More specifically, the inductance elements L1 and L2 are coupled with the spiral-shaped coupling units 32a and 32b owing to eddy currents, as described below.

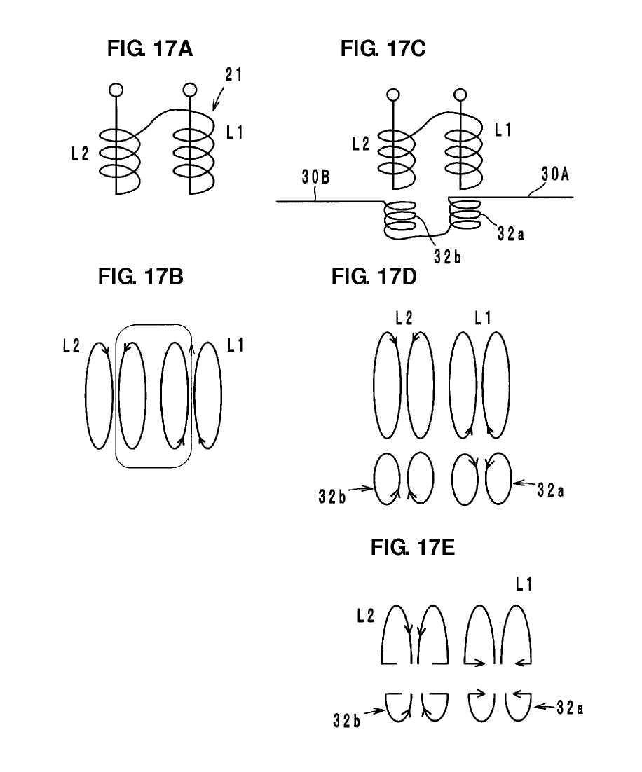

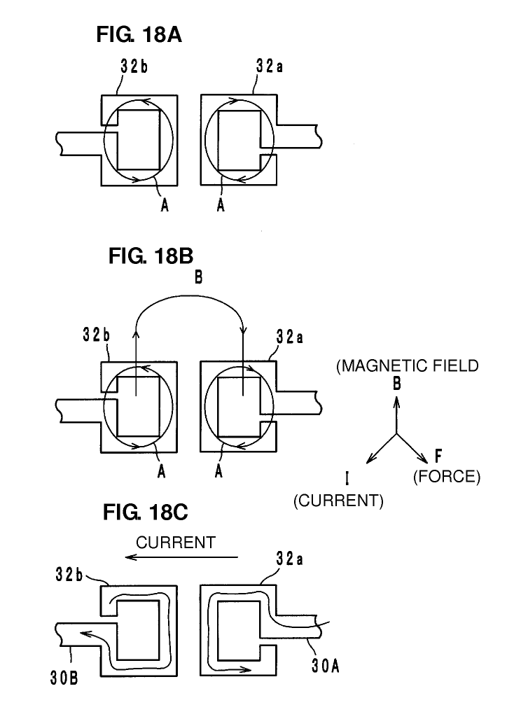

Here, coupling between the power feeding circuit 21 and the radiation plates 30A and 30B will be described with reference to FIGS. 17A-17E and FIGS. 18A-18C. First, since the inductance elements L1 and L2 are wound in directions opposite to each other (refer to FIG. 17A, and the current paths are mirror-reversed, magnetic fields are also reversed, and a far magnetic field becomes zero. Therefore, the power feeding circuit substrate 20 does not function as an antenna. In addition, since the elements L1 and L2 are wound in directions opposite to each other, a magnetic field flows as one closed loop, and does not leak to the outside (refer to FIG. 17B). A closed magnetic circuit is formed in such a way, and hence a portion of energy is not radiated further other than coupling as in usual magnetic field coupling.

As illustrated in FIG. 17C, when focusing attention on the spiral-shaped coupling units 32a and 32b facing the inductance elements L1 and L2, magnetic fields are generated in the coupling units 32a and 32b, the directions of the magnetic fields being opposite to those of magnetic fields formed by the elements L1 and L2 facing the coupling units 32a and 32b, respectively (refer to FIG. 17D, and the magnetic fields of the elements L1 and L2 are blocked out (refer to FIG. 17E). Since the coupling units 32a and 32b are also wound in directions opposite to each other, the directions of magnetic fields individually occurring in the coupling units 32a and 32b are opposite to each other. Owing to the magnetic fields, eddy currents A occur in the coupling units 32a and 32b (refer to FIG. 18A). Since the coupling units 32a and 32b are adjacent to each other and directions in which the eddy currents A flow are opposite to each other in adjacent portions, a closed-loop secondary magnetic field B occurs (refer to FIG. 18B). Electrons for the neutralization of a magnetic field attempt to flow from one end portion to the other end portion with originating from the secondary magnetic field B. In addition, even if the radiation plates 30A and 30B are separated into two portions, currents flow into and from the adjacent coupling units 32a and 32b from and to the outside, and currents flow through the radiation plates 30A and 30B (refer to FIG. 18C).

In other words, the coupling units 32a and 32b receive the magnetic field B, and a current I occurs and receives a force F. In each of the coupling units 32a and 32b, since the directions of the magnetic field B and the current I are reversed, the force F received by electrons turns out to have the same direction, as the radiation plates 30A and 30B, and currents turn out to flow through the radiation plates 30A and 30B.

A function in which the spiral-shaped coupling units 32a and 32b are coupled with each other owing to eddy currents and the effects thereof are the same as described in the eddy current coupling of the plate-shaped coupling units 31a and 31b. Accordingly, the description of a function effect in the first preferred embodiment is also applied to the present third preferred embodiment of the present invention.

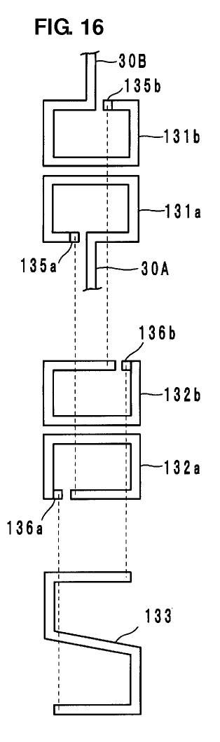

Here, the laminated structures of the spiral-shaped coupling units 32a and 32b will be described with reference to FIG. 15 and FIG. 16. End portions of the radiation plates 30A and 30B are connected to end portions of the loop-shaped wiring electrodes 131a and 131b, respectively, and the other end portions of the electrodes 131a and 131b are connected to end portions of loop-shaped wiring electrodes 132a and 132b in the second layer through via hole conductors 135a and 135b. The other end portions of the electrodes 132a and 132b are connected to a wiring electrode 133 in the third layer through via hole conductors 136a and 136b. The spiral-shaped coupling units 32a and 32b are interlinked through the electrode 133, and the radiation plates 30A and 30B turn out to be formed using one conductive wire. If the wavelength of a signal is λ, it is desirable that the lengths of such radiation plates 30A and 30B are the integral multiple of λ/2.

In addition, in FIG. 15 and FIG. 16, the spiral-shaped coupling units 32a and 32b have been illustrated preferably as structures in which wiring electrodes are formed and laminated in a substrate. However, in addition to this, the spiral-shaped coupling units 32a and 32b may also be configured by shaping a copper line into a spiral shape.

### Other Preferred Embodiments

In addition, the wireless IC device and the coupling method according to the present invention are not limited to the above-mentioned preferred embodiments, and it should be understood that various other preferred embodiments, and combinations and modifications thereof may occur insofar as they are within the scope thereof.

For example, the wireless IC may not be a chip type, and may be formed in the power feeding circuit substrate in an integrated fashion. In addition, various shapes may be adopted for the radiation plate.

The individual radiation plates and the individual power feeding circuit substrates that have been illustrated in the above-mentioned preferred embodiments and examples of modifications may be arbitrarily combined. In addition, it should be understood that the configuration of the power feeding circuit is not limited to the above-mentioned preferred embodiments.

As described above, preferred embodiments of the present invention are useful for a wireless IC device, and in particular, are superior in terms of being capable of coupling a power feeding circuit with a radiation plate with a very high degree of coupling due to eddy currents.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A wireless IC device comprising:
a wireless IC;
a power feeding circuit coupled with the wireless IC and including a resonant circuit and/or a matching circuit including at least two inductance elements; and
a radiation plate arranged to radiate a transmission signal supplied from the power feeding circuit and/or supply a received signal to the power feeding circuit; wherein
the at least two inductance elements are spiral shaped and wound in directions opposite to each other and winding axes of each of the at least two inductance elements are disposed at different positions; and
the radiation plate includes two plate-shaped coupling units, and the plate-shaped coupling units are disposed in a vicinity of the at least two inductance elements so as to be nearly perpendicular to the winding axes of the at least two inductance elements, respectively.

2. The wireless IC device according to claim 1, wherein the radiation plate has a loop shape originating from the two plate-shaped coupling units.

3. The wireless IC device according to claim 1, wherein the radiation plate includes a first radiation plate and a second radiation plate, said first and second radiation plates are arranged to originate and extend from the two plate-shaped coupling units.

4. The wireless IC device according to claim 1, wherein the two plate-shaped coupling units are disposed in a vicinity of each other.

5. A wireless IC device, comprising
a wireless IC;
a power feeding circuit coupled with the wireless IC and including a resonant circuit and/or a matching circuit including at least two inductance elements; and
a radiation plate arranged to radiate a transmission signal supplied from the power feeding circuit and/or supply a received signal to the power feeding circuit; wherein
the at least two inductance elements are spiral shaped and wound in directions opposite to each other and winding axes of each of the at least two individual inductance elements are disposed at different positions; and
the radiation plate includes two spiral-shaped coupling units, the spiral-shaped coupling units are disposed in a vicinity of the at least two inductance elements so that spiral surfaces thereof are nearly perpendicular to the winding axes of the at least two inductance elements, respectively, and the spiral-shaped coupling units are wound in directions opposite to the winding directions of the at least two inductance elements adjacent to the spiral-shaped coupling units, respectively.

6. The wireless IC device according to claim 5, wherein the radiation plate includes one conductive wire.

7. The wireless IC device according to claim 5, wherein a length of the radiation plate is an integral multiple of λ/2.

8. The wireless IC device according to claim 1, wherein a resonance frequency of the transmission signal and/or the reception signal corresponds to a resonance frequency of the resonant circuit.

9. The wireless IC device according to claim 1, wherein first end portions of the at least two inductance elements are conductively connected to each other, and second end portions of the at least two inductance elements are individually coupled with the wireless IC.

10. The wireless IC device according to claim 1, wherein individual inductance values of each the at least two inductance elements are substantially equal to each other.

11. A coupling method for a power feeding circuit including a resonant circuit and/or a matching circuit including at least two inductance elements and a radiation plate arranged to radiate a transmission signal supplied from the power feeding circuit and/or supply a received signal to the power feeding circuit; wherein
the at least two inductance elements are spiral shaped and wound in directions opposite to each other and winding axes of each of the at least two inductance elements are disposed at different positions;
the radiation plate includes two plate-shaped coupling units; and
the two plate-shaped coupling units are formed to be disposed in a vicinity of the at least two inductance elements so as to be nearly perpendicular to the winding axes of the at least two inductance elements, respectively, and eddy currents are caused to occur in the two plate-shaped coupling units so as to couple the power feeding circuit and the radiation plate with each other.

12. A coupling method for a power feeding circuit including a resonant circuit and/or a matching circuit including at least two inductance elements and a radiation plate arranged to radiate a transmission signal supplied from the power feeding circuit and/or supply a received signal to the power feeding circuit; wherein
the at least two inductance elements are spiral shaped and wound in directions opposite to each other and winding axes of the at least two inductance elements are disposed at different positions;
the radiation plate includes two spiral-shaped coupling units; and
the two spiral-shaped coupling units are disposed in a vicinity of the at least two inductance elements so that spiral surfaces thereof are nearly perpendicular to the winding axes of the at least two inductance elements, respectively, the spiral-shaped coupling units are wound in directions opposite to the winding directions of the inductance elements adjacent to the spiral-shaped coupling units, respectively, and eddy currents are caused to occur in the two spiral-shaped coupling units so as to couple the power feeding circuit and the radiation plate with each other.

13. The coupling method for the power feeding circuit and the radiation plate according to claim 11, further comprising a step of connecting a wireless IC to the power feeding circuit.
